(19) United States
(12) Patent Application Publication
(10) Pub. No.: US 2014/0279799 A1
(43) Pub. Date: Sep. 18, 2014

(54) PROVIDING REWARDS BUCKETS AND SAVINGS TOWARDS SPECIFIC GOALS

(71) Applicant: BANK OF AMERICA CORPORATION, Charlotte, NC (US)

(72) Inventors: Susan Smith Thomas, Gastonia, NC (US); Laura Corinne Bondesen, Charlotte, NC (US); David M. Grigg, Rock Hill, SC (US)

(73) Assignee: BANK OF AMERICA CORPORATION, Charlotte, NC (US)

(21) Appl. No.: 13/804,869

(22) Filed: Mar. 14, 2013

(51) Int. Cl. G06N 5/02

(52) U.S. Cl. CPC G06N 5/025
USPC 706/47; 706/55

(57) ABSTRACT

Embodiments of the invention relate to systems, methods, and computer program products for providing a rewards program. The system, method, and computer program product are configured to determine that a customer has completed an action; determine that the customer has earned a reward based on the action; determine a category associated with the reward; and apply the reward to the category. In some situations, the categories are default categories provided by the financial institution. In other situations, the categories are defined by the customer. The system determines which category an earned award is routed into using a decision engine that evaluates the award and/or the action completed by the customer and compares the award and/or action to rules, such as default rules, custom rules, or dynamic rules. The categories may also include goals and the system assists in tracking customer's progress towards the goal.

### BACKGROUND

Many merchants, e.g. retailers, financial institutions, provide their customers with a customer loyalty rewards program. Typically, customers that participate in these programs receive some defined benefit in exchange for continuing to be an active customer of the merchant. Because customer loyalty rewards programs are becoming increasingly popular with customers, there is a need to improve the ways in which merchants implement and provide such programs.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In an aspect, a system for providing a rewards program is provided. In some embodiments, the system includes a computer apparatus including a processor and a memory; and a software module stored in the memory, comprising executable instructions that when executed by the processor cause the processor to: determine that a customer has completed an action; determine that the customer has earned a reward based on the action; determine a category associated with the reward; and apply the reward to the category.

In some embodiments, determine when a goal in at least one category has been completed; and update the category based on completion of the goal. The category may defined by the customer, defined by the merchant, or defined by a combination of the customer and the merchant. In some embodiments, the category associated with the reward is determined using a decision engine comprising at least one rule, wherein the decision engine compares at least one of the reward or the action to the rule to determine the category associated with the reward. In further embodiments, the action is selected from the group consisting of a financial transaction, a social media action, a life event action, and a financial institution relationship action. In a still further embodiment, at least one category comprises a goal, and wherein the processor is further configured to determine when the reward associated with category causes the goal to be reached. In some embodiments, the processor is further configured to update the category when the goal has been reached. Updating the category may include completing the goal on behalf of the customer.

In a further aspect, a computer program product for providing a rewards program is provided. In some embodiments, the computer program product includes a non-transitory computer readable storage medium having computer readable program code embodied therewith, the computer readable program code comprising: a computer readable program code configured to determine that a customer has completed an action; a computer readable program code configured to determine that the customer has earned a reward based on the action; a computer readable program code configured to determine a category associated with the reward; and a computer readable program code configured to apply the reward to the category.

In some embodiments, the computer program product further includes a computer readable program code configured to determine when a goal in at least one category has been completed; and a computer readable program code configured to update the category based on completion of the goal. The category may be defined by the customer. In a further embodiment, the category associated with the reward is determined using a decision engine comprising at least one rule, wherein the decision engine compares at least one of the reward or the action to the rule to determine the category associated with the reward. In a still further embodiment, the action is selected from the group consisting of a financial transaction, a social media action, a life event action, and a financial institution relationship action. In a yet still further embodiment, at least one category comprises a goal, and wherein the computer program product further comprises computer readable code configured to determine when the reward associated with category causes the goal to be reached. The computer program product may also include computer readable code configured to update the category when the goal has been reached. In some embodiments, updating the category comprises completing the goal on behalf of the customer.

In a still further aspect, a method for providing a rewards program is provided. In some embodiments, the method includes using a computer processor comprising computer program code instructions stored in a non-transitory computer readable medium, wherein said computer program code instructions are structured to cause said computer processor to: determine that a customer has completed an action; determine that the customer has earned a reward based on the action; determine a category associated with the reward; and apply the reward to the category.

In a further embodiment, the method includes determining when a goal in at least one category has been completed; and updating the category based on completion of the goal. The category may be defined by the customer or the merchant. In some embodiments, the category associated with the reward is determined using a decision engine comprising at least one rule, wherein the decision engine compares at least one of the reward or the action to the rule to determine the category associated with the reward. In further embodiments, at least one category comprises a goal, and wherein the computer program product further comprises computer readable code configured to determine when the reward associated with category causes the goal to be reached.

Other aspects and features, as recited by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating a high-level process flow for a system and method for implementing a rewards program, in accordance with embodiments of the invention;

FIG. 2 is a flow diagram illustrating a process flow for categorizing rewards from customer actions into category buckets, in accordance with embodiments of the invention;

FIG. 3 is an exemplary screenshot of a graphical representation of a customer's progress towards goals in categories, in accordance with embodiments of the invention;

FIG. 4 is a block diagram of a financial institution's banking system, in accordance with some embodiments of the invention; and

FIG. 5 is a block diagram illustrating exemplary technical components of a system for implementing a rewards program, in accordance with an embodiment of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” It should also be understood that while some embodiments describe the methods or products as comprising one or more elements, the methods or elements may also consist of or consist essentially of the elements disclosed herein.

Although embodiments of the present invention described herein are generally described as involving a merchant, it will be understood that merchant may involve one or more persons, organizations, businesses, institutions and/or other entities such as financial institutions, services providers that implement one or more portions of one or more of the embodiments described and/or contemplated herein.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer.

Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, apparatus, systems, methods and computer program products are herein disclosed for implementing a rewards program. Inasmuch as financial institutions often offer customers a rewards program, specific embodiments disclosed herein relate to financial institutions. However, such embodiments are exemplary.

FIG. 1 illustrates a general process flow 100 for an apparatus or system for implementing a rewards program consistent with an embodiment of the present invention. In some embodiments, the system determines that a customer has completed an action; determines that the customer has earned a reward based on the action; determines a category associated with the reward; and applies the reward to the category. The system may also track progress towards a goal within a category, inform the user when the goal is reached, and complete the goal on behalf of the user (e.g., purchase a product that the user has been saving towards).

As shown in block 110, the system determines that a customer has completed an action. In some embodiments, the customer is a customer of the merchant, e.g., the financial institution offering the rewards program. The customer may register for various rewards offered by the financial institution and use the system and method to track rewards within various categories towards goals. In some embodiments, the customer is not a financial services customer of the merchant offering the rewards program but receives rewards for actions from other businesses or activities. For example, the customer may have registered to receive rewards based on use of a credit card. The customer may desire for the rewards received for sue of the credit card to be tracked according to the claimed system and method. In this embodiment, the customer may link the rewards offering of the credit card to the claimed system and method, e.g., such as providing username and password to access the rewards. In some embodiments, the claimed system and method merely tracks the rewards earned by the user of the credit card. In other embodiments, however, the claimed system and method transfers the rewards earned by the user of the credit card to a rewards currency stored by the provider of the claimed system and method.

In an exemplary embodiment, the rewards are fully convertible between currencies. For example, airline miles may be converted to cash back rewards or vice versa. In one embodiment, the system provides a single currency into which all rewards currencies may be converted. In a further embodiment, a rewards marketplace is provided that allows users to trade rewards for other types of rewards with different users and/or reward providers.

In some embodiments, the system monitors the customer's actions using a computing device processor. For example, the system may continuously monitor the user's actions, regularly monitor the user's actions (e.g., one a predetermined time period such as every night), or monitor the user's actions based on a prompt from the user (e.g., the user requests the system to update the user's rewards and actions in the system). The type of monitoring will depend on the action that is being monitored. For example, in some embodiments actions include financial transactions, social media actions, and financial institution relationship actions. When monitoring financial transactions, the system may monitor the user's payment methods and transaction registers to determine that a user has completed an action.

Action may include, but are not limited to, becoming a new customer of the merchant, participating in a new program or service provided by the merchant (e.g. enrolling in a bill pay program provided by a financial institution, opening a new account, utilizing an online bill paying service, receiving electronic monthly statements, accessing the financial institution website or a specified portion of a website), maintaining a specified balance in an account (e.g. maintaining $500 or more in a savings account), meeting specific goals (e.g. depositing $50 a month into a savings account for six months, spending $10 or more every week at a grocery store), donating money to a charity, completing transactions with a specified financial instrument (e.g. a designated credit card or debit card), referring other customers to become customer of the merchant, and the like.

Monitoring the customer's action may be done in any manner sufficient to determine that the customer has completed an action. However, in some embodiments monitoring the customer's actions will involve monitoring the transactional data and/or customer account history data available to the merchant. Transactional data includes, but is not limited to, data regarding the date, location, amount, method of payment, or other characteristics (e.g., frequency, time), of the transactions of the customer. Account history data includes, without limitation, such data as the types of accounts the customer has with the merchant (e.g. credit, checking, savings, investment, lay-away, financing.) and the current and historical balances of such accounts, account activity. Accordingly, by way of example, if a merchant has assigned a reward to completing a transaction with its debit card, the merchant may be able to refer to the available transactional data to identify the method of payment used in the customer's transactions and determine when the customer has used the merchant's debit card. Similarly, if the merchant, e.g. a financial institution, has assigned a reward to enrolling in a new savings account, the account history data will allow the financial institution to determine when the activity has been completed.

A customer's activities may also be monitored by monitoring a mobile device of the user, social network data, and Internet data about the customer available to the merchant. In an embodiment, a “mobile device” is a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. In some embodiments, the user's location is determined based on the mobile device and the system determines that the customer has completed an action, e.g., being at a store at a specific time, based on the mobile device data.

It will be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity. The social network may be a web-based social structure or a non-web-based social structure. In some embodiments, the social network may be inferred from financial transaction behavior, mobile device behaviors. The social network may be a network unique to the invention or may incorporate already-existing social networks as well as any one or more existing web logs or “blogs,” forums and other social spaces. Social network data may provide information regarding the customer's recent, present or future actions through expressed data. For instance, a user may upload a blog post, comment on a connection's page, send a friend an electronic message that indicates that the user likes the merchant or encourages the user's connections to use the merchant's services. Similarly, a user might post a statement indicating that she purchased a luxury item, such as jewelry or new shoes suggesting that the customer has exceeded a budget limitation or failed to meet a savings goal. Checking in at or liking merchants or other locations is another social media action of the user that may be monitored.

Monitoring a customer's activities may also be done by monitoring Internet data associated with the customer. Internet data, may include any information relating to the searches conducted by the customer, website's visited by the customer and the like that suggests the customer's activities. For instance, a customer may access a financial institution's website to enroll in a “Bill Pay” service or to elect to receive financial statements in an electronic form.

In some embodiments, a financial institution relationship action may be another type of action that can be monitored. Financial institution relationship actions include maintaining one or more accounts or types of accounts at a financial institution. For example, opening a savings account at the financial institution where the customer already has a checking account is an action that can be monitored. The action is the change in the relationship between the financial institution and the customer. By providing rewards for changing the relationship between the financial institution and the customer, the financial institution is able to provide an incentive to customers to increase their contact with the financial institution.

It should be understood that other types of actions may also be monitored by the system. For example, life stage actions such as getting married, having a child, buying a house, starting a new job, retiring, or moving to a new location may all be life stage actions that may be monitored.

In an embodiment, the system determines that the action has been completed when the action is cleared by the merchant. For example, a customer may make a purchase at a business. The purchase shows as pending in the customer's transaction record until the financial institution clears the transaction. In further embodiments, the system determines that the action has been completed when the action is initiated by the customer. For example, the system may determine that an action is completed when the purchase shows as pending.

In block 120, the system determines that the customer has earned a reward based on the action. Customers earn rewards as incentives to perform actions in many different areas of their lives. For example, merchants may wish to provide incentives to purchase their products, payment method providers may wish to provide incentives for customers to use their payment methods, or financial institution may wish to provide incentives for customers to use more services at the financial institution. Various award schemes are available but due to the different currencies of reward types and varied locations, earning potentials, and redemption policies, rewards often expire or go unused.

Such rewards can be any incentive or inducement to encourage the customer to complete an action and include, but are not limited to discounts for goods or services provided by the merchant discounts for goods or services provided by other merchants, offers for services otherwise unavailable to the customer (e.g. VIP services, preferred customer services), reductions in services charges, and the like.

In one embodiment, the rewards are designed and/or offered by a financial institution to encourage specific actions by the user. The rewards may be educational or motivational. In some embodiments, a first action performed by a user results in rewards that are categorized in a first category and a second, less encouraged action performed by the user results in different rewards and/or rewards that are categorized in a second category. For example, users may receive a first type of reward for using an ATM to make a deposit but a second type of reward for using a cashier to make a deposit. It should be understood that other types of actions may be encouraged by differentiating the rewards and/or categories that are assigned to the actions by the financial institution.

In some embodiments, the rewards comprise discounts for goods or services within general categories, such as electronics, travel, office and school supplies, health and beauty, apparel and the like. In some embodiments, the rewards will be valid for a limited period of time (e.g. the discount must be redeemed within thirty days). In some embodiments the reward may be an opportunity to participate in a game of chance.

In an exemplary embodiment, the reward is a travel reward such as airline, hotel, or membership miles or points. The reward may be earned based on spend for a credit card or debit card, or other action of the customer. In some embodiments, the reward is earned for travel itself, such as spending nights in hotels, number of airline miles traveled, or the like. In an embodiment, a customer may use points earned toward travel for free or decreased price travel rewards, or for upgrades during travel. In a further embodiment, points may be earned to allow a customer to make reservations before others that have not used points. For example, points may be used to allow the customer to purchase tickets to a concert before the tickets go on sale to the public.

In a further embodiment, the reward is a financial reward, such as cash back. In some embodiments, the user must accumulate a specific amount of rewards before the user may receive the financial reward. For example, the user may be required to accumulate a set dollar amount of rewards before the user can receive a check for the amount. In another embodiment, the customer has a choice to receive cash back at one reward level or a discount towards a product or service at a different reward level. For example, the customer may be required to reach $100 in reward points before receiving a cash back reward of $100 but may be able to apply $50 towards a purchase when the customer has only $50 accumulated.

In a still further embodiment, the reward is a service level reward, such as increase service, access to higher level customer service, an assigned representative, or a concierge that assists with special requests.

In some embodiments, a reward is earned when the action is completed. In further embodiments, the customer must sign up for or request rewards once an action is completed. In some embodiments, the system signs the customer up or requests the reward on behalf of the customer. The reward may be deposited in the customer's account or available for download and/or transfer to the customer.

In a further embodiment, a reward is earned based on extended progress toward a goal or extended completion of an action. For example, a user may receive a reward based on length of time or number of default or user-defined milestones that are reached while progressing towards a goal in a category. In this embodiment, the action is persistence towards a goal. For example, the user may have a goal of savings towards a retirement account. The user may make regular contributions to the retirement account and after making twelve consecutive monthly contributions, the system determines that the user has completed an action based on the extended progress toward the goal and provide a reward to the user.

In a still further embodiment, a reward is lost or removed if the user completes a default or user-defined action. In one embodiment, a user will receive a reward if a certain action is not completed. If the user instead completes the action, the user does not receive the reward. For example, the user may receive a reward if the user does not write a check during a month (e.g., the user uses a direct transfer or debit card instead). If the user writes a check during that month, the user loses the reward that would have been received. Similarly, in an embodiment, the user may have an earned reward removed if a specific action is completed by the user. For example, a user may have earned a reward for extended progress toward an emergency savings goal. If, however, the user removes funds from the emergency savings account prior to reaching the goal, the user may lose a previously earned reward. In one embodiment, rewards that were earned for the extended progress are rescinded.

In block 130, the system determines a category associated with the reward. A category is an established bucket for receiving rewards. For example, the category may be a “student loan” category and the rewards in the category are used to pay towards a student loan. The category may also be a product or service that the user desires, for example a “television” category, or a “spring break trip” category.

In some embodiments, the categories are default categories provided by the merchant. For example, the merchant may establish default categories for best financial practices, e.g., an “emergency fund” category, a “bill pay” category, and a “life insurance” category. The default categories may be available to customers automatically or by selection from a list. For example, the customer may access a plurality of default categories and select the categories that the customer would like to use for savings goals.

In further embodiments, the categories are customer-defined categories. For example, the customer may include categories for planned purchases or goals. In one embodiment, the customer inputs the desired categories as well as a goal amount.

It should be understood that the default categories provided by the merchant, or by a third party, may be modified by the user. For example, the default categories may include an emergency fund category that can be modified by the customer with the appropriate amount for the customer's needs (e.g., the goal that the customer desires for an appropriate emergency fund).

The categories may also be divided into long-term and short-term categories. For example, saving a down payment for a home may be a long term goal but buying a new television may be a short term goal. Categories may be time limited as well. For example, a category may be defined as savings for the current month or savings for the current year. In an embodiment, customers may compare their categories to other categories to compare savings goals.

In an embodiment, a decision engine determines which category the reward is associated with. In an embodiment, the decision engine determines the category based on one or more rules for categorizing the rewards. In an embodiment, the decision engine is a processor and memory configured to cause computer readable code to perform specific actions. The decision engine receives information on the customer's action, the earned reward, and in some embodiments additional information regarding the customer's financial actions. For example, the system may receive the action, the earned reward, and the transaction history of the user for one or more accounts.

In an embodiment, the decision engine determines the category the reward is associated with based on default rules. Default rules are rules determined by the merchant or by the reward provider. For example, the merchant may set a default rule that all rewards points earned at a specific store are delivered to a category set up for the store. For example, a grocery store may provide rewards points based on purchases at the grocery. The merchant may receive these rewards and place them in a category established for the grocery, which could then be used to receive discounts on future purchases. The reward provider may also establish default rules, such as airline miles credit cards that by default provide rewards in a travel category associated with the airline.

In a further embodiment, the rules may be custom rules defined by the customer. The custom rules may be modifications of the default rules or may be completely defined by the customer. Custom rules can be as specific or as general as the customer prefers. For example, the custom rule may be based on the day of the week that the customer is completing an action. In one embodiment, the custom rule may be a rule that routes all rewards earned Monday-Friday into a first category and rewards earned on Saturday and Sunday into a second category. This custom rule, or a variation of it, may be useful to customers that differentiate between awards earned during business travel and awards earned during personal time. The custom rule may be a dynamic or static rule. Dynamic rules are rules that categorize the reward based on a characteristic of the reward or the action completed to earn the reward. Static rules are rules that categorize awards into a specific category regardless of the characteristics of the transaction or award.

In some embodiments, the customer defines the dynamic custom rule based on a characteristic of the reward. For example, the customer may establish rules based on the size of the reward, the time that the reward was received, the location of the reward, and the like. A reward above a predetermined threshold value may be categorized into a first category whereas a reward below the predetermined threshold value is categorized into a second category. In other embodiments, the customer defines the dynamic custom rule based on a characteristic of the action that resulted in the reward. For example, the action may be a transaction and thus the characteristics of the transaction include the amount of the transaction, the date of the transaction, the payment method, the merchant with whom the transaction was conducted or the like. In this example, a transaction above a certain amount may be categorized into a first category and below the amount will be categorized into a second category regardless of the size of the award.

In some embodiments, one or more rules are provided to the customer as suggested rules based on the customer's transaction history or relationship with the merchant. For example, the merchant may determine that the user could pay insurance premiums by routing all rewards from grocery purchases into an insurance premium category. A financial institution is in a unique position to provide this additional service to customers because the financial institution offering the rewards program to customers has access to transaction data, earned rewards, and expenses. The system may determine that the average rewards earned for a specific type or combination of rewards is sufficient in amount or value to cover an ongoing expense of the customer. The suggested rule may be provided to the user via an online bill pay system, via an email, or other contact method.

As discussed, in some embodiments a category includes a goal. For example, a travel category may include a goal of a trip to Europe for the following summer. Similarly, a product category may include the goal of purchasing the product. In some embodiments, however, the category does not have a goal. For example, an emergency fund category may not have a set goal but instead receive all rewards that are placed into it.

In block 140, the system applies the reward to the category. In some embodiments, the system applies the reward to the category by tracking rewards and storing information regarding the total number of rewards the user has earned. Turning briefly to FIG. 3, the system may track the customer's progress toward a goal by graphically displaying the amount or value of rewards within a category and the distance or relative distance to the goal.

Turning now to decision block 150, the system determines whether the goal has been met. In some embodiments, goals are in the same currency as the reward. For example, the reward may be a cash back reward and the goal may be a television costing a certain amount. When the cash back reward equals the amount to buy the television, the goal is reached. In a further embodiment, goals are in a different currency as at least one type of reward in the category. For example, a travel reward category with a goal such as a plane ticket may include frequent flyer miles, cash back rewards, and rewards for purchases made at a grocery store. When the aggregate value of the rewards in the travel category equals the plane ticket, the goal is reached. The system may convert the cash back rewards and grocery rewards into frequent flyer miles, either through trading with other users that desire a trade in the opposite direction or through selling and purchasing rewards in a category based on market value. For example, the cash back rewards can be used to purchase frequent flyer miles.

If the goal is not met after applying the reward to the category, the system continues to monitor the customer's actions for earned rewards. In some embodiments, the system sends a message to the customer informing the customer of the progress towards the goal, including how many more rewards are needed, the rate that the customer has been approaching the goal, the predicted time and/or date that the goal will be reached based on historical rewards earning, and other information related to the goal. In some embodiments, the system also informs the customer of how the user can accelerate rewards earnings towards the goal. For example, the system may inform the customer to change behavior such that increased rewards are directed to the goal. In some embodiments, the change in customer behavior is based on pre-existing actions of the customer such that no additional expenses are incurred. For example, the customer may earn rewards towards a goal when purchasing gas at a first gas station but not when purchasing gas at the second gas station. The system may recommend to the customer that by switching to purchasing gas at the first, rewards-earning gas station, the customer can accelerate the progress towards the goal.

If the goal is met after applying the reward to the category, the system updates the category, as shown in block 160. In some embodiments, updating the category includes changing the goal in the category, eliminating the category and diverting the rewards to a different category, or the like. In some embodiments, the system also fulfills the goal of the customer. For example, if the goal is tickets to a concert once sufficient rewards points are earned, the system may automatically purchase the tickets when the goal is reached.

FIG. 2 provides a general process flow 200 for a system and method of classifying rewards into categories having goals, in accordance with an embodiment of the invention. In an embodiment, the system identifies actions completed by a customer, determines a reward that the customer receives, and routes that reward into specific categories based on rules. In some embodiments, the categories have goals associated with them. In one example, actions may include transactions 210, social media actions 220, and financial institution relationship actions 230. By completing an action, the customer earns a reward, such as Reward A 212, Reward B 222, or Reward C 224. A decision engine 235 determines the category that the reward is applied to, based on rules such as custom rules 240, dynamic rules 250, or default rules 260. In this way, the rewards are placed into buckets associated with categories and, in some embodiments, accumulate until a goal is reached. For example, the category buckets may be travel rewards 270, cash rewards 280, or service level rewards 290.

In a specific embodiment, the action is a transaction 210 conducted by the user. For example, the transaction may be a financial transaction having characteristics X, Y, and Z. The transaction 210 may have an amount X, have been performed at a merchant Y, and performed with payment method Z. Completing the transaction 210, such as finishing the purchase at the merchant Y, may be determined by the system and result in Award A 212. For example, the Award A 212 may be a cash rebate of a specific amount. It should be understood that the characteristics of the transaction 210 are for example purposes only.

In another embodiment, the customer may also complete a social media action 220. The social media action 220 may be checking in on a social network at various locations of a specific hotel chain. In some embodiments, the social media action 220 earns the customer a reward, such as Award B 222. Award B may be points towards a free night, generic hotel loyalty points, or the like.

In a still further embodiment, the customer may complete a financial institution action 230, such as opening a new account at the financial institution or reaching a specific balance in a pre-existing account. Once the customer completes the action 230, the customer receives an award C 232. Again, award C 232 may be generic points towards the financial institution service or specific reward scheme that the financial institution has for receiving higher levels of service. For example, the financial institution may provide a special customer service line to individuals that have at least four different types of accounts with the financial institution so that the individual has a higher chance of speaking with a customer service representative who is knowledgeable about various account types.

The system uses the decision engine 235 to route the awards 212, 222, and 232 to the appropriate category buckets 270, 280, and 290. In an exemplary embodiment, the decision engine 235 evaluates the action 210, 220, 230 and/or the award 212, 222, 232 based on rules associated with the customer. The rules may be custom rules 240, dynamic rules 250, or default rules 260. In an embodiment, a plurality of rules are established for the customer's account such that different rewards are routed based on different types of rules. For example, financial institution relationship actions may always be routed according to default rules, while rewards from other types of actions are routed via different types of rules.

As discussed, a custom rule 240 is a rule established or defined by the customer. In an example, the custom rule 240 may be a rule that all rewards based on transactions are routed into the cash rewards 280 category, as shown in FIG. 2. The custom rule 240 is different from a dynamic rule because the characteristics of the action, i.e., the amount X, the merchant Y, or the payment method Z, do not affect how the award A is routed. A dynamic rule, in contrast, would have evaluated at least one of the amount X, the merchant Y, the payment method Z, or the award A 212, to determine which category the award A 212 should be routed to.

As discussed, a dynamic rule 250 is a rule that routes a reward based on the characteristics of the action or the characteristics of the award. In this example, the dynamic rule is used to route award B 222 based on the social media action 220. For example, the dynamic rule may be a rule that causes all social media awards earned prior to a predefined date to be routed to the travel reward category 270 and all social media awards earned after the predefined date to be routed to cash rewards category 280. The user may define this dynamic rule because the user is planning a vacation on the predefined date and would like to accumulate reward points towards the hotel for the vacation. The goal is a free night at the hotel, but in some embodiments, even if the goal is not reached, the points can be used to reduce the cost or receive extra amenities at the hotel.

In some embodiments, the default rule 260 is used to route rewards. For example, the financial institution may have preset rules which route specific types of rewards to specific categories. In some embodiments, the default rule 260 may be changed by the customer but in other embodiments the default rule cannot be changed by the customer.

The categories, which may be defined by the merchant or the customer, receive the awards based on the decision engine 235. For example, the travel reward category 270 may be a category defined by the user to receive all rewards associated with future travel plans of the user. The category may include but travel-specific awards, such as frequent flyer miles, and generic awards that may be used for travel, such as cash rebates or discounts for products which could be used to purchase travel-related products. In this example, the goal for the travel reward category 270 is a free night at a hotel, and the customer's reward earned for checking in at a hotel on social media gets the customer closer to reaching that goal.

The customer may also have a cash reward category 280, which has as a goal a specific amount, or a service level reward category 290, which has as a goal a specific service level. As rewards are earned by the customer, the categories fill up based on the routing of the decision engine 235 until the goals are reached or the customer redeems lesser rewards. The customer may also request transfer of rewards from one category to another at any time.

Referring now to FIG. 3, an exemplary display page 300 illustrating customer interfaces for implementing a rewards program consistent with embodiments of the present invention is provided. It will be understood that the display page 300 can be embodied as portions of a dashboard application, portions of a portal application, as intranet pages, as Internet web pages, as the display associated with a mobile application, and/or the like.

The exemplary display page 300 provides graphical information to the customer on the customer's progress in categories and towards goals. In the example, goals 302 are listed on the X-axis. The goals 302 may be default goals, such as gold status, or customer-defined goals, such as plane tickets and cash back. The goals are within categories 304, such as a travel category, a cash rewards category, and a service level category. The graphical depiction includes a depiction of the current level of rewards 306 in the category and a target level of rewards 308 in order to reach the goal 302. In some embodiments (not shown), the customer may select a category or goal and receive additional information related to the customer's actions. For example, the customer may select on the plane ticket category and be shown all of the actions and rewards that have been assigned to the category. In some embodiments, the customer may move rewards from one category to another category in this manner.

It should be understood that the exemplary screenshot is but one example of the graphical depictions that may be provided to a customer related to the system and method. Bar charts, pie graphs, and other graphical depictions, as well as registers of rewards, actions, and goals may be provided to the customer via the merchant's webpage or an application on a mobile device.

FIG. 4 provides a block diagram illustrating an exemplary banking system 400 in greater detail, in accordance with embodiments of the invention. The banking system 400 may be the merchant system that provides for the system and method disclosed in FIGS. 1-3. As illustrated in FIG. 4, in one embodiment of the invention, the banking system 400 includes a processing device 420 operatively coupled to a network communication interface 410 and a memory device 450. In certain embodiments, the banking system 400 is operated by a first entity, such as a financial institution, while in other embodiments the banking system 400 is operated by an entity other than a financial institution.

It should be understood that the memory device 450 may include one or more databases or other data structures/repositories. The memory device 450 also includes computer-executable program code that instructs the processing device 420 to operate the network communication interface 410 to perform certain communication functions of the banking system 400 described herein. For example, in one embodiment of the banking system 400, the memory device 450 includes, but is not limited to, a network server application 470, a customer account data repository 480, which includes customer account information 484, a decision engine 490, a customer monitoring routine 492, and other computer-executable instructions or other data. The computer-executable program code of the network server application 470 or the customer monitoring routine 492 may instruct the processing device 420 to perform certain logic, data-processing, and data-storing functions of the banking system 400 described herein, as well as communication functions of the banking system 400.

In some embodiments, the customer monitoring routine 492 facilitates monitoring of the customer's actions based on financial transactions, social media actions, relationship data, life event data, and mobile device data. For example, the customer monitoring routine 492 may establish a connection with the mobile device, may encrypt or decrypt communications with the mobile device, or may determine the customer's location when making a purchase based on the mobile device.

As used herein, a “communication interface” generally includes a modem, server, transceiver, and/or other device for communicating with other devices on a network, and/or a user interface for communicating with one or more users. Referring again to FIG. 4, the network communication interface 410 is a communication interface having one or more communication devices configured to communicate with one or more other devices on the network, such as the mobile device, the merchants, and the banking system 400. The processing device 420 is configured to use the network communication interface 410 to transmit and/or receive data and/or commands to and/or from the other devices connected to the network 250 to allow communication between the devices.

FIG. 5 provides a block diagram illustrating technical components for a system 500 for implementing a rewards program, in accordance with an embodiment of the present invention. As illustrated, the system 500 includes a customer 510, a merchant computer platform 520, a mobile device 530 and a network 540. It will be understood that the customer 550 has access to the mobile device 530.

As shown in FIG. 5, the merchant computer platform 520 and mobile device 530 are each operatively and selectively connected to the network 540, which may include one or more separate networks. In addition, the network 540 may include a local area network (LAN), a wide area network (WAN), and/or a global area network (GAN), such as the Internet. It will also be understood that the network 540 may be secure and/or unsecure and may also include wireless and/or wireline technology.

The mobile device 530 may include any computerized apparatus that can be configured to perform any one or more of the functions of the mobile device 530 described and/or contemplated herein. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. As shown in FIG. 5, in accordance with some embodiments of the present invention, the mobile device 530 includes a communication interface 532, a processor 533, a memory 534 having a browser application 535 stored therein, a positioning system device 536, such as a GPS device, and a user interface 537. In such embodiments, the communication interface 532 is operatively and selectively connected to the processor 534, which is operatively and selectively connected to the user interface 537, the memory 534 and the positioning system device 536.

The user interface 538, which may allow the mobile device 530 to receive data from the customer 550, may include any of a number of devices allowing the mobile device 530 to receive data from the customer 550, such as a keypad, keyboard, touch-screen, touchpad, microphone, mouse, joystick, stylus, other pointer device, button, soft key, and/or other input device(s). In some embodiments, the user interface 538 also includes one or more user output devices, such as a display and/or speaker, for presenting information to the customer 550.

Each communication interface described herein, including the communication interface 532 and 522, generally includes hardware, and, in some instances, software, that enables a portion of the system 500, such as the processor 533 to transport, send, receive, and/or otherwise communicate information. For example, the communication interface 532 of the mobile device 530 may include a modem, server, electrical connection, and/or other electronic device that operatively connects the mobile device 530 to another electronic device, such as the electronic devices that make up the merchant computer platform 520.

Each processor described herein, including the processor 533 and 524, generally includes circuitry for implementing the audio, visual, and/or logic functions of that portion of the system 500. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as the memory 534 of the mobile device 530 and the memory 526 of the merchant computer platform 526.

Each memory device described herein, including the memory 536 for storing the browser application 535 and other data and/or programs, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 534 of the mobile device 530 includes a browser application 535. The browser application 535 in some embodiments may be used by the customer 550 to access over the network 540 a secure website maintained by the merchant for viewing information about the customer's received rewards and to track progress towards rewards. In some embodiments, the browser application 535 includes computer-executable program code portions for instructing the processor 534 to perform one or more of the functions of the browser application 535 described and/or contemplated herein. In some embodiments, the browser application may be configured to a collect and transmit through the communication interface data regarding the customer's actions to enable the merchant to determine when one or more actions have been completed. In some embodiments, the browser application 535 may include and/or use one or more network and/or system communication protocols.

It will be understood that the mobile device 530 can be configured to implement one or more portions of the process flows described and/or contemplated herein. For example, in some embodiments, the user interface apparatus 530 is configured so that the communication interface 532 is operatively and selectively linked to the merchant computer platform 520 to update the category upon reaching a goal. For instance, information regarding the rewards credited to the customer may be displayed on the display of the user interface 537, e.g. the display may show the customer's balance of points, the amount of points needed to reach a goal, a graphical representation of the progress towards specific rewards, or the like. As discussed, the customer 510 may be able to access a secure website via the browser application 535 and the communication interface 532 accessing the merchant computer platform over the network 540. In other embodiments (not shown) an application may be stored in the memory 534 of the mobile device 530 that enables the mobile device to perform some or all of the steps of process flow 100 shown in FIG. 1. In further embodiments, the mobile device may determine the location of the customer 510 by information provided by the positioning system device 536 that the customer 510 is near location where she can redeem one or more of the rewards received as part of the rewards program. For example, the customer may have received a reward for twenty percent off any purchase from a local hair salon. The GPS device in the customer's mobile phone may determine that the customer is within two hundred feet of the hair salon and provide an alert, such as a visual display, vibration, audible warning alerting the customer to the opportunity to redeem a reward.

FIG. 5 also illustrates a merchant computer platform 520, in accordance with an embodiment of the present invention. The merchant computer platform 520 may include any computerized apparatus that can be configured to perform any one or more of the functions of the merchant computer platform 520 described and/or contemplated herein. In accordance with some embodiments, for example, the merchant computer platform 520 may include an engine, a platform, a server, a database system, a front end system, a back end system, a personal computer system, and/or the like. In some embodiments, such as the one illustrated in FIG. 5, the merchant computer platform 520 includes a communication interface 522, a processor 524 and a memory 526. In some embodiments, as illustrated in FIG. 5, customer data (such as transactional data, account history data, social network data and Internet data) 527, a marketplace application 526 and a customer monitoring routine 529 may be stored in memory 526. The customer data 527 may have been previously collected and stored in the memory 526 of the merchant computer platform 520, or the merchant computer platform may actively collect customer data 527 by using the communication interface 522 to access the network 540 and only temporarily saves the customer data 527 to the memory to be accessed by the processor 524. The communication interface 522 is operatively and selectively connected to the processor 524, which is operatively and selectively connected to the memory 526.

It will be understood that the merchant computer platform 520 can be configured to implement one or more portions of the process flows described and/or contemplated herein. For example, in some embodiments, the merchant computer platform 520 is configured so that the processor assigns rewards to a customer's completion of certain activities. In certain embodiments the customer monitoring routine 529, stored in memory 526 is configured to monitor the customer's activities, including the customer data 527, to determine when the customer has completed an action. In yet other embodiments, the decision engine 528 stored in memory 526 is configured to credit the rewards to the correct category for the completed actions based on the rules.

It will be understood that the embodiment illustrated in FIG. 5 is exemplary and that other embodiments may vary. For example, in some embodiments, some or all of the portions of the system 500 may be combined into single portion. Specifically, in some embodiments, the merchant computer platform 520 is configured to perform all of the same functions of those separate portions as described and/or contemplated herein. Likewise, in some embodiments, some or all of the portions of the system 500 may be separated into two or more distinct portions.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing a rewards program, the system comprising:
a computer apparatus including a processor and a memory; and
a software module stored in the memory, comprising executable instructions that when executed by the processor cause the processor to:
determine that a customer has completed an action;
determine that the customer has earned a reward based on the action;
determine a category associated with the reward; and
apply the reward to the category.

2. The system of claim 1, wherein the module is further configured to:
determine when a goal in at least one category has been completed; and
update the category based on completion of the goal.

3. The system of claim 1, wherein the category is defined by the customer.

4. The system of claim 1, wherein the category associated with the reward is determined using a decision engine comprising at least one rule, wherein the decision engine compares at least one of the reward or the action to the rule to determine the category associated with the reward.

5. The system of claim 1, wherein the action is selected from the group consisting of a financial transaction, a social media action, a life event action, and a financial institution relationship action.

6. The system of claim 1, wherein at least one category comprises a goal, and wherein the processor is further configured to determine when the reward associated with category causes the goal to be reached.

7. The system of claim 6, wherein the processor is further configured to update the category when the goal has been reached.

8. The system of claim 7, wherein updating the category comprises completing the goal on behalf of the customer.

9. A computer program product for providing a rewards program, the computer program product comprising:
a non-transitory computer readable storage medium having computer readable program code embodied therewith, the computer readable program code comprising:
a computer readable program code configured to determine that a customer has completed an action;
a computer readable program code configured to determine that the customer has earned a reward based on the action;
a computer readable program code configured to determine a category associated with the reward; and
a computer readable program code configured to apply the reward to the category.

10. The computer program product of claim 9, the computer program product further comprising a computer readable program code configured to determine when a goal in at least one category has been completed; and a computer readable program code configured to update the category based on completion of the goal.

11. The computer program product of claim 9, wherein the category is defined by the customer.

12. The computer program product of claim 9, wherein the category associated with the reward is determined using a decision engine comprising at least one rule, wherein the decision engine compares at least one of the reward or the action to the rule to determine the category associated with the reward.

13. The computer program product of claim 9, wherein the action is selected from the group consisting of a financial transaction, a social media action, a life event action, and a financial institution relationship action.

14. The computer program product of claim 9, wherein at least one category comprises a goal, and wherein the computer program product further comprises computer readable code configured to determine when the reward associated with category causes the goal to be reached.

15. The computer program product of claim 14, wherein the computer program product further comprises computer readable code configured to update the category when the goal has been reached.

16. The computer program product of claim 15, wherein updating the category comprises completing the goal on behalf of the customer.

17. A method for providing a rewards program, the method comprising:
using a computer processor comprising computer program code instructions stored in a non-transitory computer readable medium, wherein said computer program code instructions are structured to cause said computer processor to:
determine that a customer has completed an action;
determine that the customer has earned a reward based on the action;
determine a category associated with the reward; and
apply the reward to the category.

18. The method of claim 17, the method further comprising determining when a goal in at least one category has been completed; and updating the category based on completion of the goal.

19. The method of claim 18, wherein the category is defined by the customer.

20. The method of claim 17, wherein the category associated with the reward is determined using a decision engine comprising at least one rule, wherein the decision engine compares at least one of the reward or the action to the rule to determine the category associated with the reward.

21. The method of claim 17, wherein at least one category comprises a goal, and wherein the computer program product further comprises computer readable code configured to determine when the reward associated with category causes the goal to be reached.
